(19) United States
(12) Patent Application Publication
(10) Pub. No.: US 2011/0184881 A1
(43) Pub. Date: Jul. 28, 2011

(54) System and method for managing and using a competitive media site

(76) Inventors: Preston Riggs, Dallas, TX (US); Darius Safavi, Dallas, TX (US); Jeff Dickason, Dallas, TX (US)

(21) Appl. No.: 12/657,565

(22) Filed: Jan. 22, 2010

(51) Int. Cl. G06Q 99/00; A63F 9/24

(52) U.S. Cl. 705/347; 463/43; 463/42

(57) ABSTRACT

A system and method for enabling networked computer users to manage and use a competitive media site is disclosed. A particular embodiment includes receiving a first and second content item from one or more content sources via a network; using a processor to initiate a competition in which users can submit ratings in support of either the first or the second content item; designating either the first or the second content item as a winning content item of the competition based on the user submitted ratings; and awarding points to winners of the competition, the winners including users who submitted ratings in support of the winning content item.

### TECHNICAL FIELD

This patent application relates to networked content and media sources, according to one embodiment, and more specifically, to enabling networked computer users to manage and use a competitive media site.

### BACKGROUND

The content available to networked computer users has increased significantly in recent years. Providers of such content include media sources, video/audio sources, blogs, news sources, sports sources, weather sources, libraries, computer users, friends, universities, businesses, and the like. Many of these content sources provide new or changed content regularly. Because of the large amount of available and often-changing content, users often seek mechanisms that help them find the best content and content sources that interest them. Unfortunately, existing systems are typically driven by a small group of reviewers who review and rate some content items for quality according to standards that may not comport with widely-held opinion. Other systems simply use a click-through count to infer the quality of content based on the number of users who access and view the content. However, because of the inherent unreliability of the quality ratings provided by these conventional systems, currently available technologies fail to accurately assess the true quality and value of particular content items including media items.

### BRIEF DESCRIPTION OF THE DRAWINGS

The various embodiments is illustrated by way of example, and not by way of limitation, in the figures of the accompanying drawings in which:

FIG. 1 illustrates an example embodiment of a system and method for enabling networked computer users to manage and use a competitive media site;

FIG. 2 illustrates a detail of the content receiver in an example embodiment;

FIG. 3 illustrates detail of the media competition system of an example embodiment;

FIG. 4 illustrates the roles management module of an example embodiment;

FIG. 5 illustrates the competition management module of an example embodiment;

FIGS. 6-14 illustrate example display screen snapshots of example embodiments;

FIG. 15 illustrates another example embodiment of a networked system in which various embodiments may operate;

FIG. 16 is a processing flow chart illustrating an example embodiment of a media competition system as described herein; and

FIG. 17 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for enabling networked computer users to manage and use a competitive media site is disclosed. In various embodiments, a competitive environment is used to enable the comparison and scoring of objects in a head-to-head competition. The competitive environment provides a solution to accurately assess the true quality and value of particular content items. In a particular embodiment, the competition can be denoted as a war. When media items are involved in the competition, the competition can be denoted as a media war. In an example embodiment, a media war can be a competition, an event, or a game between multiple competitors wherein the competitors compete using various objects, such as media. In one embodiment, the game is played on a website. In a particular embodiment, a webpage is used to display at least two objects (or representations of same) on the website. In one embodiment, the objects can be media items, such as videos, audio clips, animations, images, graphics, avatars, and the like. In other embodiments, the objects can be representations of physical objects, products, people, events, documents, creative works, business entities, expressed ideas, and the like. As described herein, these objects can be denoted as content items or media items. In a manner described in more detail below, users/competitors rate the content items according to criteria of the user's own choosing in the context of a competition, an event, or a game denoted herein as a media war. The objective of each competitor is to win the game by performing any of the following actions in the following roles: winning a media war as a General, winning a media war as a Soldier, or winning a bid as a Speculator. These game actions and competitor roles in various example embodiments are described in more detail below. At the end of a determined time period, each content item (e.g., media) within a media war will finish with a final score based on the ratings and bids provided by users. The competitors who have supported the winning content item (e.g. the competing content item with the highest score), either as a general, soldier, or speculator, are the resultant winners of the media war. The competitors who have supported the losing content item (e.g. the competing content item with the lowest score), either as a general, soldier, or speculator, are the resultant losers of the media war. Winning competitors can have points added to their personal cumulative point totals in varying amounts based on their role in the competition. Losing competitors can have points deducted from their personal cumulative point totals in varying amounts based on their role in the competition. In the sections provided below, the details of the media war competition in a particular embodiment are fully described. Firstly, a definition of terms used in an example embodiment is provided. Secondly, the roles a user/competitor may assume in a competition are detailed. Thirdly, the details of declaring a media war, defending a media war, bidding in a media war, and ending a media war in a competition of a particular embodiment are provided.

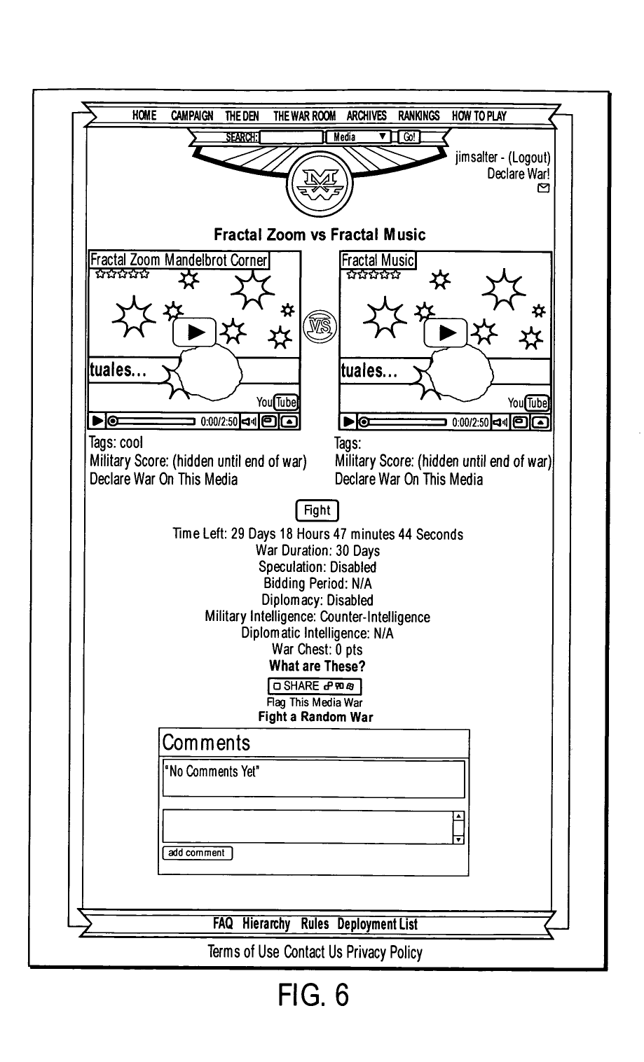

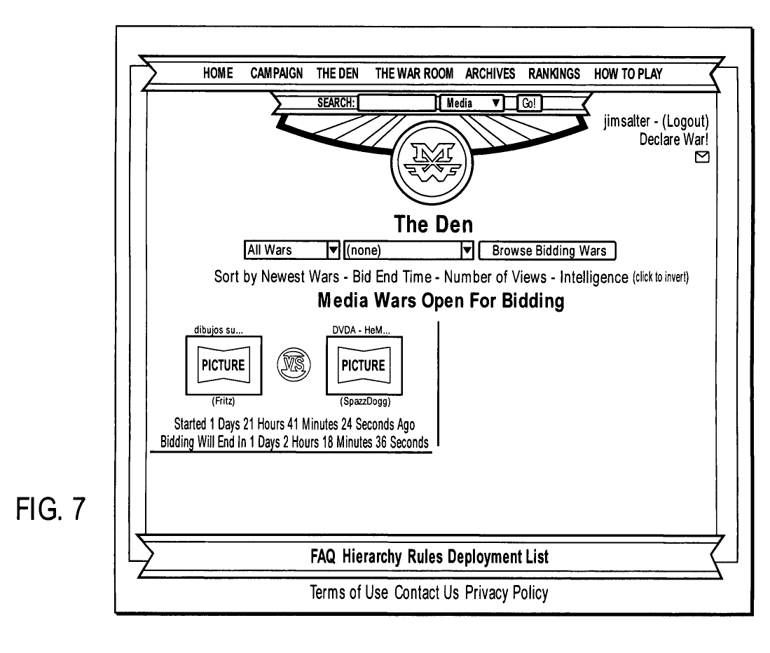

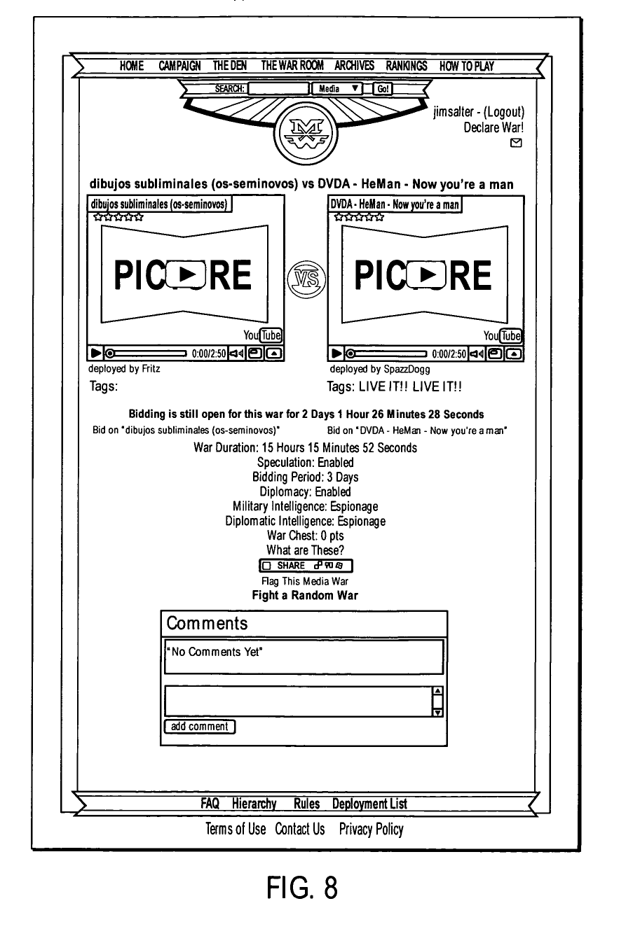

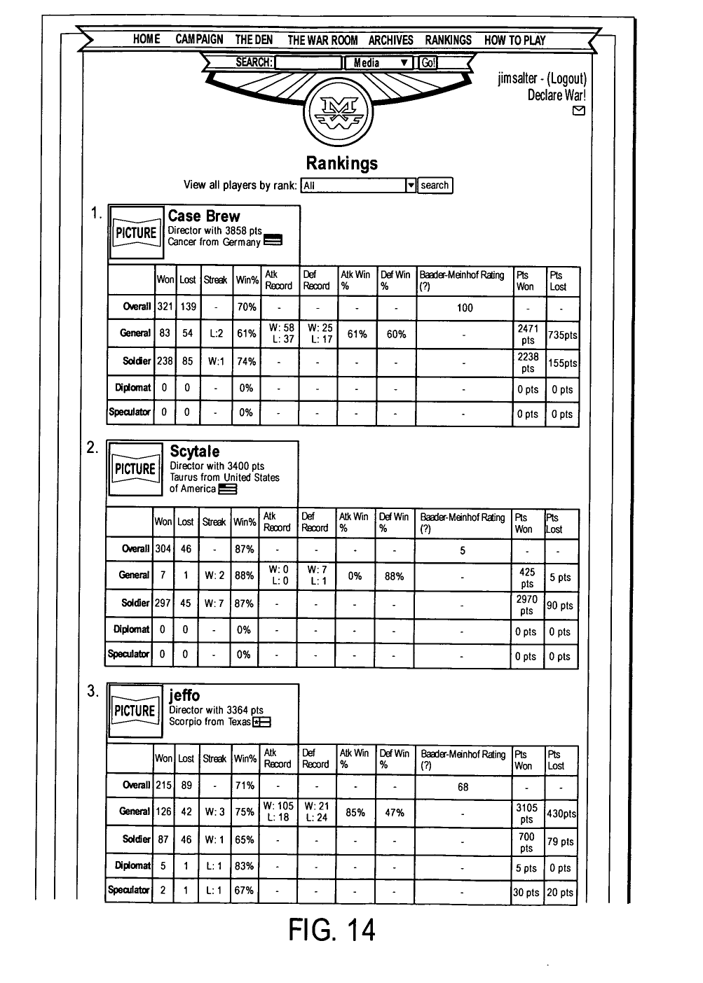

Definition of terms in an example embodiment:
ALLEGIANCE—The media for which a certain player or players fight. In other words, the content items competitors support in a media war by giving a particular content item a more favorable rating or score.
ARCHIVES—The primary location where players browse and access completed media wars.
ATTACK—An action where players, acting as generals, deploy content items in a competition and initiate a media war against other players.
BAADER-MEINHOF RATING—The frequency that a player's deployed content item has been rated and/or scored compared to all other players.
BID—A wager of points between players.
BID HISTORY—Relevant statistics derived from players' previous bids.
BID FREQUENCY LIMIT—A limit on the number of times a bidder may bid.
BID PAGE—The location where players engage in wagering points against other players (e.g., see FIG. 8).
COUNTER-INTELLIGENCE—A form of score display wherein the score of media wars are displayed when the media wars finish.
DECLARE WAR—Deploying content items in a competition with the purpose of creating a media war between competitors.
DEFEND—An action where players respond to attacks by other players.
THE DEN—The location where players browse and access media wars which are available for bidding (e.g., see FIG. 7).
DEPLOYMENT LIST—A summary or list of all content sources which players or the host site may visit/access and from which players or the host site can deploy content items in order to allow players to engage in a media war competition on the hose site.
EARLY TERMINATION—The action wherein an Umpire or the Executive Council elects to end a media war before its previously specified duration has elapsed. When this occurs, a winner is declared, a loser is declared, points are allocated to winning soldiers and generals, points are deducted from losing soldiers and generals, bid points are allocated to bid winners, and all statistics are finalized and displayed in player accounts.
ESPIONAGE—A form of Intelligence wherein the score of media wars are displayed to players once players have fought the media war.
EXECUTIVE COUNCIL—A group of administrative officials of a host site who are responsible for maintaining the overall integrity of the media wars competition on the host site.
FEATURED WARS—A collection of media war competitions which are displayed more prominently than other media wars.
FIGHTING—The action of rating/scoring a media war.
GENERALS—Players who deploy content items in order to declare media wars and thereby create media wars.
HERALD—The Media Wars notification bot.
HIERARCHY—A divided list which separates players into various rankings based on the points players have acquired. For example: 1. Viewer—0 points, 2. Candidate—400 points, 3. Broadcaster—1500 points, 4. Archivist—5000 points, 5. Director—10,000 points, 6. Executive Producer—20,000 points, 7. Kingpin—40,000 points, 8. Vice Commissioner—85,000 points, 9. Commissioner—175,000 points, 10. Mogul—500,000 points.
NULLIFICATION—A media war in which none of the following occur: a winner declared, a loser declared, point exchanges, point allocations. Only Umpires and the Executive Council retain the right to perform this action.
OPEN ATTACK—A media war in which a player declares war on a defender, and the defender has not yet responded.
OPEN DEFENSE—A media war in which an attacker declares war on another player, and that other player has not yet responded.
INTELLIGENCE—A Term of Engagement which mandates the manner in which scores are displayed.
NEWBIE—A person who has not yet registered with a host site player account.
PLAYERNAME—An identification tool in which a player may distinguish him or herself from other players.
SOLDIERS—Players who fight media wars (e.g., competitors who rate or score content items in a media war).
SPECULATORS—Players who bid on media wars (e.g., competitors who bid or wager points on content items in a media war).
SURVEILLANCE—A form of Intelligence wherein all scores are displayed throughout the media war.
PROJECTED RESULT—The estimated final score of media wars that are currently in progress. Applies only to Surveillance and Espionage types of media wars.
TERMS OF ENGAGEMENT—A number of factors determined by attackers which customize various aspects of a media war.
UMPIRE—An official who is responsible for maintaining the integrity of competition on a host site.
WAR ARCHIVE—The primary location where players may browse statistics which pertain to specific finished competitions.
WAR CHEST—An initial bid made by an attacker against a defender.
WAR HISTORY—A set of data which represents the players' comprehensive competitive histories.
WAR PAGE—The location where players engage in fighting media wars (e.g., see FIG. 6).
THE WAR ROOM—The primary location where players may browse and access active media wars (e.g., see FIG. 14).

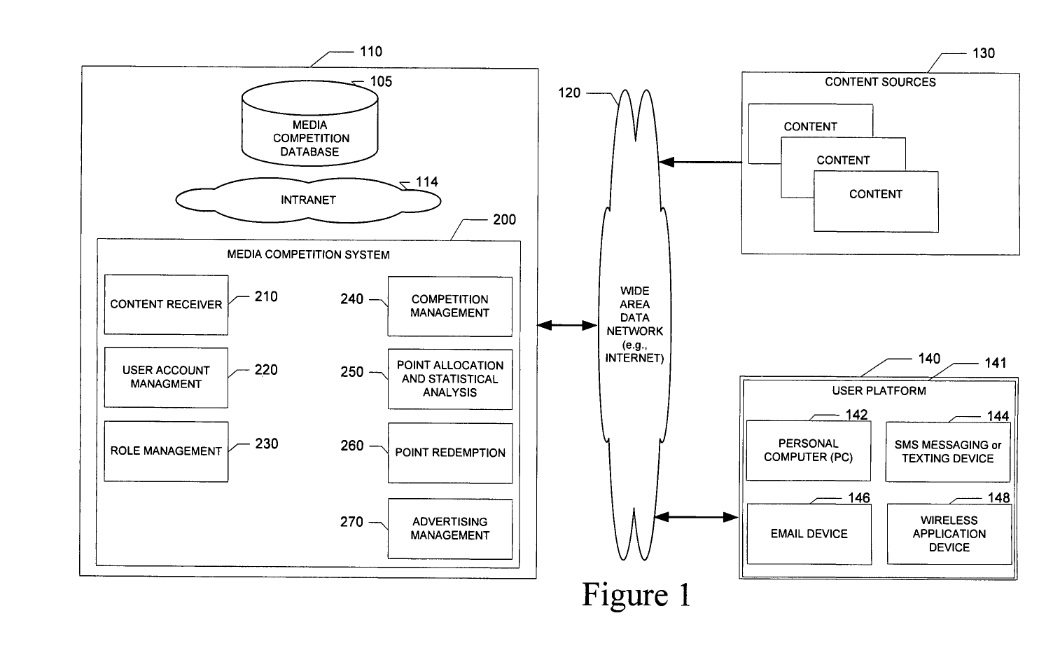

Referring now to FIG. 1, in an example embodiment, a system and method for enabling networked computer users to manage and use a competitive media site is disclosed. In various example embodiments, an application or service, typically operating on a host site (e.g., a website) 110, is provided to simplify and facilitate competitive media management for a user at a user platform 140 from the host site 110. Content sources 130 provide a plurality of content sources from which content items of a competition (e.g., media items, other objects, or representations of physical objects) may be obtained. Such content items are denoted herein as objects or media. One or more of the content sources 130 can be provided by one or more content publishers or content aggregators operating at various locations in a network ecosystem. For example, the conventional website www.youtube.com is one example of such a content aggregator that may be represented by content sources 130. It will be apparent to those of ordinary skill in the art that content sources 130 can be any of a variety of networked content providers or content aggregators as described in more detail below. In a particular embodiment, a deployment list maintained at the host site 110 can be used as a summary or list of all content sources 130 which players or the host site 110 may visit/access and from which players or the host site 110 can deploy content items in order to allow players to engage in a media war competition on the hose site 110. The competitive media management (host) site 110, content sources 130, and user platforms 140 may communicate and transfer content and information in the data network ecosystem shown in FIG. 1 via a wide area data network (e.g., the Internet) 120. Various components of the competitive media management site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The content sources 130 may include any of a variety of providers of network transportable digital content, some of which may be RSS (Really Simple Syndication) feeds, denoted generally as content, content items, or media. The network transportable digital content can be transported in any of a family of file formats and associated mechanisms usable to enable a host site 110 and a user platform 140 to receive content from a content source 130 over a network 120. In one embodiment, the file format can be XML (Extensible Markup Language), however, the various embodiments are not so limited, and other file formats and transport protocols may be used. For example, content formats other than HTML/XML or formats other than open/standard feed formats can be supported by various embodiments. Any electronic file format, such as Portable Document Format (PDF), audio (e.g., Motion Picture Experts Group Audio Layer 3—MP3, and the like), video (e.g., MP4, and the like), and any proprietary interchange format defined by specific content sites can be supported by the various embodiments described herein. Furthermore, although RSS content can be used, the various embodiments are not limited to RSS. For example, Atom, a syndication specification adopted by the Internet Engineering Task Force (IETF) may also be employed. As used throughout this application, including the claims, RSS refers to RSS, Atom, and other syndication file formats derived therefrom. In one embodiment, an RSS feed may represent a summary of content formatted in an RSS format and available for access. Moreover, a content source 130 may provide more than one content item or content feed.

In a particular embodiment, a user platform 140 with one or more client devices 141 enables a user to access content from the content sources 130 via the host 110 and network 120. Client devices 141 may include virtually any computing device that is configured to send and receive information over a network, such as network 120. Such client devices 141 may include portable devices 144, 146, or 148 such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information.

Client devices 141 may also include at least one client application that is configured to receive content or/or control data from another computing device via a network transmission. The client application may include a capability to provide and receive textual content, graphical content, video content, audio content, and the like. Moreover, client devices 141 may be further configured to communicate and/or receive a message, such as through a Short Message Service (SMS), direct messaging (e.g., Twitter), email, Multimedia Message Service (MMS), instant messaging (IM), interne relay chat (IRC), mIRC, Jabber, Enhanced Messaging Service (EMS), text messaging, Smart Messaging, Over the Air (OTA) messaging, or the like, between another computing device, and the like.

Referring still to FIG. 1, host site 110 of an example embodiment is shown to include a media competition system 200, intranet 114, and media competition database 105. Media competition system 200 includes content receiver 210, user account management module 220, role management module 230, competition management module 240, point allocation and statistical analysis module 250, point redemption module 260, and advertising management module 270. Each of these modules can be implemented as software components executing within an executable environment of media competition system 200 operating on host site 110. Each of these modules of an example embodiment is described in more detail below in connection with the figures provided herein.

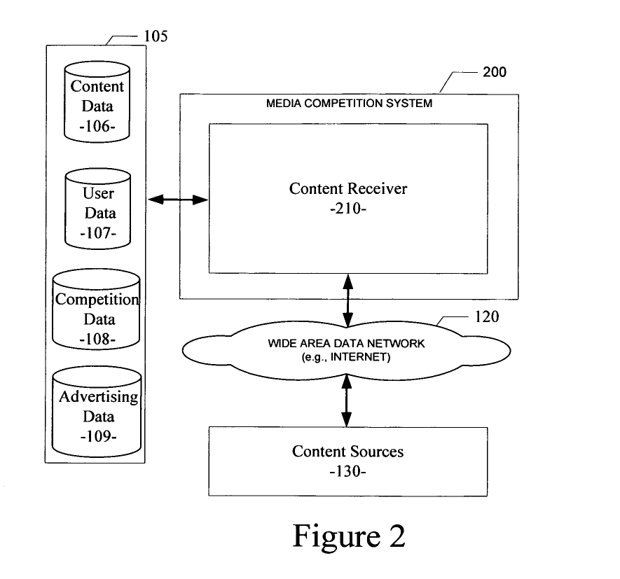

Referring now to FIG. 2, a detail of the content receiver 210 in an example embodiment is illustrated. As shown, content receiver 210 is in data communication via network 120 with a plurality of content sources 130, one or more data storage devices 105, and the other processing modules 220-270 of the media competition system 200 (not shown in FIG. 2). In general, the content receiver 210 is responsible for collecting and staging content items (e.g., media) received from a variety of content sources 130. In a particular embodiment, these content sources 130 can include individual or aggregated content sources as described above. Aggregated content sources can represent any of a variety of conventional sites or services that pull or receive media or content feeds from various sources and collect the media in a local collector. The local collector of a content source 130 may then provide these media items or content feeds to host site 110 and/or user platforms 140 via the wide area data network 120.

Content receiver 210 can be configured to interface with any of the content sources 130 via wide area data network 120. Because of the variety of content sources 130 providing media to content receiver 210, the content receiver 210 needs to manage the interface to the various content sources 130. This content source interface or content management process performed by content receiver 210 can include retaining information on each content item, content feed, or object received from a content source 130. This retained information can include an identifier or address of the corresponding content item, content feed, or object received from a content source 130, an identifier or address of the corresponding content source 130, the timing associated with the content item, content feed, or object, including the time when the latest update of an item was received and the time when the next update is expected, and the like. This information related to the content items, content feeds, or objects received from content sources 130 can be stored in content database 106.

The content management process performed by content receiver 210 can also include performing any transcoding, decompression, decryption, formatting, and/or the like that may be necessary to display a particular content item on a webpage at a client device 141 of a user platform 140 via host site 110. The content management process performed by content receiver 210 can also include the fetching, staging, and deployment of particular content items on a webpage as users of user platforms 140 declare a media war based on particular content items as described in more detail below. The competition management module 240, described in more detail below, may request the content receiver 210 to obtain and provide access to a particular content item deployed by a player for a particular media war. Additionally, the content receiver 210 can maintain a Deployment List as part of the content data 106. As described in more detail below, an attacking general(s) may deploy content which is hosted on the content sources 130 listed in the Deployment List.

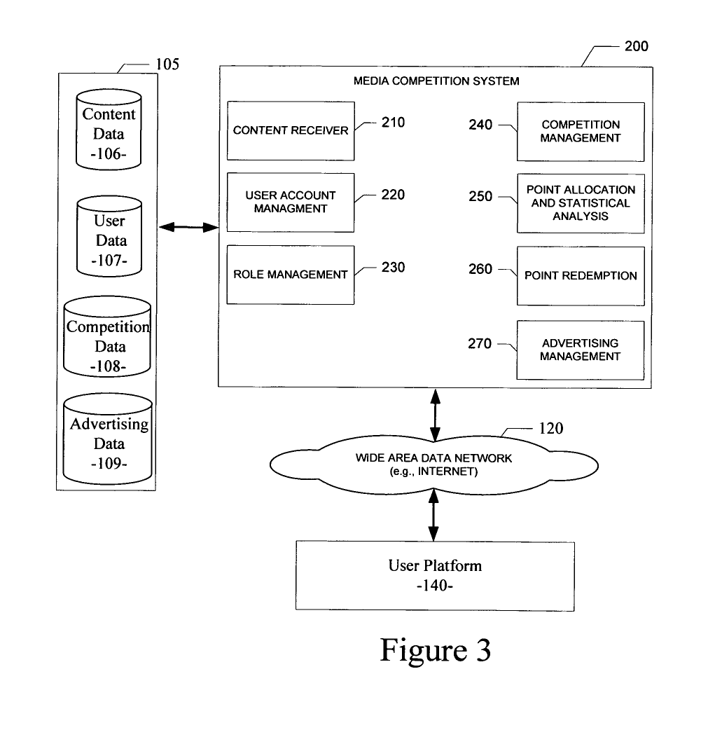

Referring now to FIG. 3, a detail of the media competition system 200 of an example embodiment is illustrated. As described above, the media competition system 200 can be executed on host system 110. The media competition system 200 may communicate and transfer content and information in the network ecosystem via a wide area data network (e.g., the Internet) 120. In this manner, the media competition system 200 may communicate and transfer content and information with a user of a user device 141 of user platform 140. In general, the user can interact with the media competition system 200 via a graphical user interface (GUI) implemented in an example embodiment as a set of webpages described in more detail below.

The media competition system 200 of an example embodiment provides a user account management module 220. The user account management module 220 provides the functionality and interfaces for a user to register with the host site 110 and create, modify, and manage a user account and related player information data sets. As part of the creation of a player information data set, a user can assign a unique identifier (also denoted a player identifier or player ID) to the player information data set. Alternatively, the user account management module 220 can automatically create and assign the player ID to the player information data set. In one embodiment, the player ID can be a unique eight digit number. In an alternative embodiment, the player ID can be an alphanumeric string of arbitrary length, which can be used to uniquely identify a particular player information data set and corresponding user. The player information data sets can be stored in user database 107.

Once the player ID is created using any of the embodiments described above, the player ID can be used by a user to access and configure user-specific information in a player information data set retained on host site 110 in a conventional manner. In a particular embodiment, a user profile can be created and maintained in user data 107. Additionally, competition data for particular players can be maintained by user account management module 220. This competition data can include cumulative point totals, current and past roles, win/loss history, bidding history, and the like. It will be apparent to those of ordinary skill in the art that other player information may similarly be configured and retained in user data 107 by the user account management module 220. Thus, for various embodiments, a user/player can register with the host site 110 and use host site 110, and the user account management module 220 therein, to create and maintain a player information data set and a corresponding unique player ID.

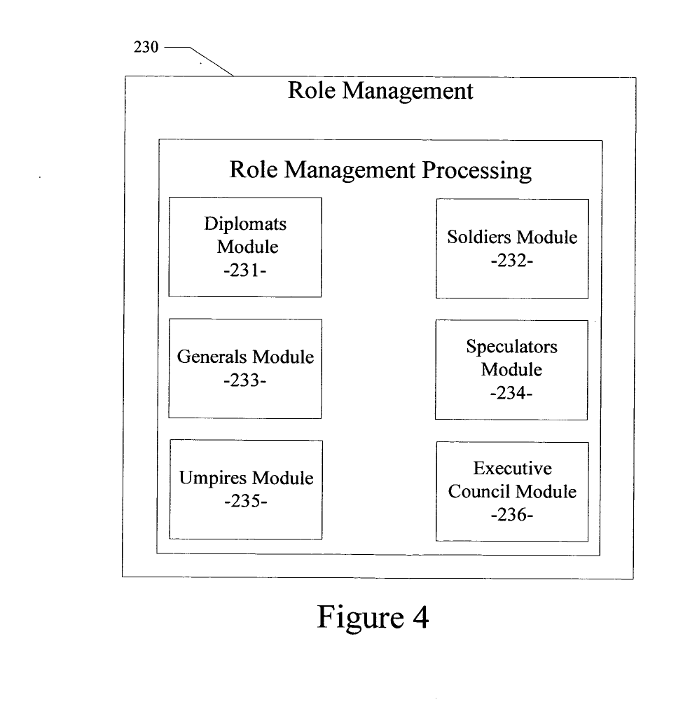

Referring now to FIGS. 3 and 4, an example embodiment of the roles management module 230 is illustrated. As described above, an objective of each user/competitor is to win a media war competition by performing any of the following actions in the following roles: winning a media war as a General, winning a media war as a Soldier, or winning a bid as a Speculator. In an example embodiment, a user may enter and/or compete in a media war competition in any of a variety of roles. Each of these roles in an example embodiment is illustrated in FIG. 4 and described in detail below.

Diplomats: A player or group of players may elect to compete in a media war as diplomats. Diplomats are players who negotiate a media war or media wars. Players who play as diplomats may also play as generals and speculators, with no restrictions. Players who play as diplomats are prohibited from playing as soldiers in the same media war in which they played as a diplomat. Players may play as any combination of diplomat, general, or speculator in any media war. When a diplomat negotiates a media war, diplomats shall bestow a numerical score upon all content items competing in a media war. Diplomats may elect to give each competing content item a rating between 1-10. Diplomats are prohibited from giving both competing content items the same score. Diplomats may elect to have allegiance with any number of competing parties against other competing parties. Diplomats are required to give allegiance to one competing content item within a media war. Diplomats are prohibited from giving allegiance to two competing parties. Diplomats give allegiance to the competing content items which they rate highest. Once diplomats click “Negotiate”, the scores they bestow to each competing content item are averaged into each competing content item's Diplomatic Score. Only diplomats who have allegiance with competing content items can earn points or lose points by negotiating in media wars. A diplomat who has allegiance with the competing content item which eventually wins the media war wins 1 point. A diplomat who has allegiance with the competing content item which eventually loses the media war neither gains nor loses points. Diplomats may negotiate as many media wars as they wish. A diplomat role instance can be created and maintained for a particular user by the diplomats module 231 as shown in FIG. 4. The diplomats module 231 can store role data and/or competition data for particular users in user database 107 and/or competition database 108.

Soldiers: A player or group of players may elect to compete in a media war as soldiers. Soldiers are players who fight in a media war or media wars. Players who compete as soldiers may also compete as generals and speculators, with no restrictions. Players may play as any combination of soldier, general, or speculator in any media war. When a soldier fights in a media war, the soldier or soldiers shall bestow a numerical rating upon all competing content items, which have been deployed into the media war(s) in which the soldier or soldiers are fighting. A soldier or soldiers may utilize any numerical rating between 1 and 10 to rate competing content items. Once a soldier or soldiers rate the competing content items, the soldier(s) score is added to the sum total of all previous ratings. The soldier(s) rating(s) are then divided by the number of total previous ratings to calculate the score, which is an average of all scores bestowed upon the particular competing content item by all soldiers participating in the media war(s). If a soldier or soldier(s) bestow a higher rating on a competing content item which is deployed by one competing party than the rating which the soldier (s) bestowed upon a competing content item deployed by a different competing party, then the soldier(s) is considered to have elected to have allegiance with the former competing party. A soldier or soldier(s) may elect to have allegiance with any number of competing parties against other competing parties. If a soldier or soldiers bestow the same rating on a competing content item as bestowed by all competing parties in any specific media war, then that soldier or soldier(s) are considered to have elected to have no allegiance with any competing parties. Only a soldier or soldiers who have allegiance with competing content item can earn points or lose points by fighting a media war. A soldier who has allegiance with the competing content item, which eventually wins the media war, wins 2 points. A soldier who has allegiance with the competing content item, which eventually loses the media war, loses 1 point. Soldiers may fight as many media wars as they wish. A soldier role instance can be created and maintained for a particular user by the soldiers module 232 as shown in FIG. 4. The soldiers module 232 can store role data and/or competition data for particular users in user database 107 and/or competition database 108.

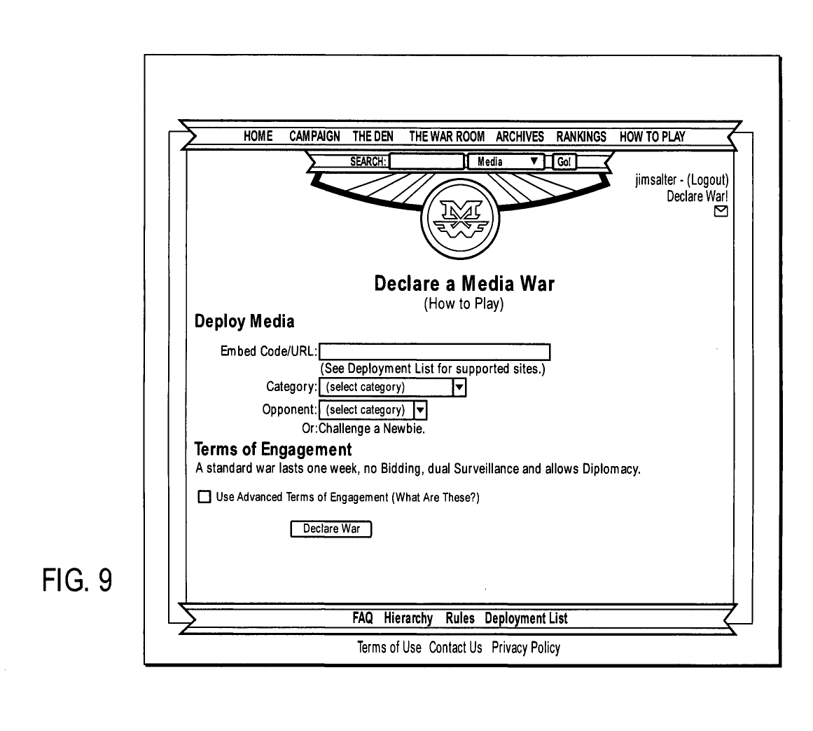

The General (Attacker): A player or group of players may elect to compete in a media war as attacking generals. Attacking generals are players who initiate a declaration of war against a defending general or group of defending generals. An attacking general shall perform the following actions, which include, but are not limited to: deploying a content item in a media war, selecting an opponent or opponents, determining the terms of engagement for any media war in which the attacking general or generals are involved, and declaring war. The attacking general(s) may deploy a content item which is hosted on sites listed in the Deployment List. In a particular embodiment, attacking generals are not permitted to deploy any content item which is not hosted on these sites listed in the Deployment List. After the attacking general or generals click “Declare War” using a declare war button provided as part of the user interface (e.g., see FIG. 9), the attacking general(s) may adjust the terms of any media war by clicking a, “Go Back and Adjust War” button also provided as part of the user interface. Once the attacking general or generals click “Attack,” the attacking general(s) may not adjust or modify the terms of any media war. Attacking generals may only declare 50 media wars per 24 hour period. Attacking generals may declare up to 50 media wars per 24 hour period against the same player, barring defense limits. If an attacking general declares a media war on a player whose defense limit is exceeded by the attacking general's media war declaration, then the attacking general will be prohibited from declaring a media war on that player until the player's defense limit time duration expires. Attacking generals may only declare a media war on players which are listed in their Players List. For a player to add another player to their players list, both parties must mutually agree to add one another to their players list. Attacking generals may declare a prospective media war against newbies, or players who do not yet have player accounts on the host site 110. By default, attacking generals who attack newbies must also request to add the newbie to the attacking general's Player List. Newbies must register, become registered players, accept the attacking general's player request, and then declare a media war against the attacking general in order for the media war to commence. Attacking generals whose competing content item has a higher score than the competing content item of the defending general(s) will win 7 points, once the media war has concluded. Attacking generals whose competing content item has a lower score than the competing content item of the defending general(s) will lose 2 points, once the media war has concluded. Attacking generals are not permitted to make any attempt to sabotage a media war by taking down, interfering with, or modifying any competing content item on the host site 110. Attacking generals are not permitted to wait until 50% of a media was has elapsed, then take down a competing content item in an attempt to gain an Early Termination win. This would be considered a form of deceptive manipulation. Any attempt to deceptively manipulate a media war will be considered cheating. A general (attacker) role instance can be created and maintained for a particular user by the generals module 233 as shown in FIG. 4. The generals module 233 can store role data and/or competition data for particular users in user database 107 and/or competition database 108.

The General (Defender): A player or group of players may elect to compete in a media war as defending generals. Defending generals are generals who declare a media war against attacking generals. Defending generals may only defend themselves from attackers in media wars in which the attacker has attacked the defender. A defending general shall perform the following actions, which include, but are not limited to: deploying a content item and declaring a media war. The defending general(s) may deploy a content item which is hosted on content source sites listed in the Deployment List. Defending generals are not permitted to deploy any content item which is not hosted on these sites. After the defending general or generals click, “Declare War”, the defending general(s) may adjust the terms of any media war by clicking “Go Back and Adjust War.” Once the defending general or generals click “Defend,” the defending general(s) may not adjust or modify the terms of any media war. In a particular embodiment, if two weeks elapses and the defender has not responded to a media war declaration, the media war is automatically declined. Defending generals may defend as many media wars as they wish during a 24 hour period. Defending generals may also set a Defense Frequency Limit. A Defense Frequency Limit limits the number of media war declarations that a defender may receive in a 24 hour period. The media competition system 200 will prohibit any attacker from declaring a media war on a defender for whom a Defense Frequency Limit has been exceeded. Defending generals may only declare a media war on players which are listed in their Players List. For a player to add another player to their players list, both parties must mutually agree to add one another to their players list. Newbies who receive media war declarations from attacking generals must first register, log in, and confirm Player Requests from any attacking generals before declaring a media war against attacking generals. Defending generals whose deployed content item has a higher score than the deployed content item of the attacking general(s) will win 7 points, once the media war has concluded. Defending generals whose deployed content item has a lower score than the deployed media of the attacking general(s) will lose 2 points, once the media war has concluded. Defending generals are not permitted to make any attempt to sabotage a media war by taking down, interfering with, or modifying any deployed content item at the host site 110. Defending generals are not permitted to wait until 50% of a media war has elapsed, then take down deployed content items in an attempt to gain an Early Termination win. This would be considered a form of deceptive manipulation. Any attempt to deceptively manipulate a media war will be considered cheating. A general (defender) role instance can be created and maintained for a particular user by the generals module 233 as shown in FIG. 4. The generals module 233 can store role data and/or competition data for particular users in user database 107 and/or competition database 108.

The Speculator: Speculators are players who bid points on deployed content items competing in a media war. Speculators may bid against other players for the purpose of winning points. Speculators may issue bids only against players who are in their Players List. Speculators may only issue bids on media wars which are currently in the bidding phase. All media wars which are in the bidding phase are located in The Den (e.g., see FIG. 7). Speculators may bid on any deployed content item which is currently in the bidding phase. Speculators may not bid on media wars for which bidding is disallowed. In a particular embodiment, speculators must issue a minimum bid of 5 points. There is no maximum bid amount. Speculators shall input the number of points they wish to bid in the Bid Amount field provided in the user interface of a particular embodiment. Once speculators click, “Issue Bid” or “Place Bid,” then the number of points which the speculator(s) entered into the bid amount field is deducted from the speculator(s) account (s). The speculator account can be maintained in the user database 107. This bid is then declared final. Once a speculator or speculators have issued bids against other players, the other player(s) may elect to accept the bid, decline the bid, or ignore the bid. If the other player(s) accept the bid, then the specified bid points are deducted from the other speculator(s) account(s). If the other player(s) decline the bid, or do not respond to the bid before the bidding phase elapses, then the media competition system 200 reimburses the points which were deducted for that specific bid back into the speculator's account. Speculator(s) who bid on the competing content item, which wins the media war, win the amount of points that the Speculator(s) bid on that media war. Speculator(s) who bid on the competing content item, which loses the media war, lose the amount of points that the Speculator(s) bid on that media war. Speculators may issue as many bids as they wish on a 24 hour basis. Players who wish to limit the number of prospective bids they receive may do so by selecting a number in the Bid Frequency Limit preference provided in the user interface of a particular embodiment. Any speculator who attempts to issue a bid against a player whose Bid Frequency Limit has been exceeded will be prohibited from issuing a bid against that player. A speculator role instance can be created and maintained for a particular user by the speculators module 234 as shown in FIG. 4. The speculators module 234 can store role data and/or competition data for particular users in user database 107 and/or competition database 108.

The Umpire: Media wars Umpires may perform any of the following actions, including but not limited to: nullifying wars, suspending accounts, deleting accounts, banning players, reporting players to the Executive Council, invoking Early Termination, deleting wars, issue warnings, and any other duties approved by the Media Wars Executive Council. All Umpires must be designated and licensed by the Executive Council. Impersonating an umpire is strictly forbidden and will result in a temporary or permanent ban. Players who dispute an umpire's official decision may appeal to the Executive Council by emailing a pre-defined email address (e.g., appeals@host.com). Players must include a hyperlink to the media war in question. Players must also furnish as much detailed information as possible regarding the media war, the umpire's decision, and the reason for their appeal. An umpire role instance can be created and maintained by an authorized representative of the host site 110 using the umpires module 235 as shown in FIG. 4. The umpires module 235 can store data for particular umpires in competition database 108.

The Executive Council: The Executive Council is the highest governing body for the media wars managed by the host site 110. The Executive Council reserves the right to perform any of the following actions, including but not limited to: nullifying media wars, suspending accounts, deleting accounts, banning players and/or umpires, invoking Early Termination, deleting media wars, issuing warnings, overruling an umpire's ruling, delegating media wars as Featured Wars, moving media wars, and any other duties deemed appropriate by the Executive Council. If a media war results in a tie, then no player who participated in that media war will receive nor lose points as a result of that tie. This applies to soldiers, generals, and speculators. If a player is suspected of cheating, or the Executive Council has reason enough to believe that a player is cheating, then the Executive Council may suspend or terminate that player's account. The Executive Council may also ban that player. It is the duty of the Executive Council to maintain the integrity of competition on the host site 110. The Executive Council holds ultimate and final power to make any decision which the Executive Council believes will maintain the integrity of competition. An executive council data structure and related functions can be created and maintained by an authorized representative of the host site 110 using the executive council module 236 as shown in FIG. 4. The executive council module 236 can store executive council data in competition database 108.

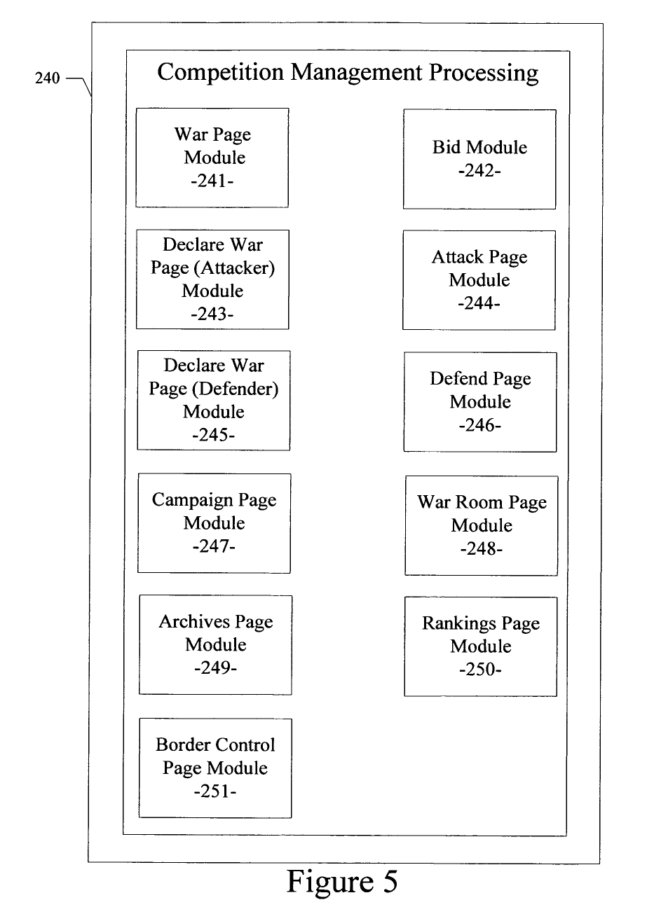

As mentioned above, the user at user platform 140 can interact with the media competition system 200 via a graphical user interface (GUI) implemented in an example embodiment as a set of webpages described in more detail below. These GUI webpages enable a user/player to interact with the media competition system 200 in the various phases of a media wars competition. In an example embodiment, these media wars competition phases can be monitored and managed using a set of processing modules that control information displayed for and received from a user/player at user platform 140 via a set of GUI webpages. In an example embodiment, these GUI webpage processing modules include a War Page module 241, a Bid module 242, a Declare War Page (Attacker) module 243, an Attack Page module 244, a Declare War Page (Defender) module 245, a Defend Page module 246, a Campaign Page module 247, a War Room Page module 248, an Archives Page module 249, and a Rankings Page module 250. Each of these processing modules and their corresponding GUI webpages as managed by the competition management module 240 is described in more detail below in connection with FIGS. 5-15.

Referring to FIG. 5, the War Page module 241 is illustrated. An example of the corresponding War Page of a particular embodiment is illustrated in FIG. 6. In the example embodiment, the War Page is structured in the following manner. The titles of each content item are displayed above each respective content item. Each content item is displayed on the war page, with ‘VS.’ dividing the competing content item from each other. Each General's player name is displayed underneath the content item which the General has deployed for the media war. Tags for each content item are displayed underneath the player name of the General. In certain media wars, a “Declare War on This Media” link will be displayed underneath the tags. Clicking on this link redirects players to a page wherein the player may declare a media war against the player who deployed the original content item, provided both players are competitors. Each content item's current score is displayed underneath each content item, depending on the Intelligence of the media war. A method for players to rate/score each content item is displayed underneath the content item. The Soldiers and Bidders for each content item are displayed underneath the method for rating, depending again on the Intelligence of the war. A rate button, or something analogous (e.g., ‘Fight’), is displayed underneath all competing content items, but centrally on the war page. The time remaining in the media war is displayed underneath the rate button, or whatever is analogous to the rate button. A link allowing players to flag the media war is displayed underneath the remaining time. A link allowing players to fight a random media war is displayed underneath the “Flag This Media War” link. Empty fields allowing players to view or make comments is displayed underneath the “Fight a Random War” link. An “Add Comment” button, which allows players to add comments, is displayed next to the empty field. Previously made comments are displayed underneath the empty field, with the name of the commenter and the time the comment was made are also displayed.

Referring again to FIG. 5, the Bid Page module 242 is illustrated. An example of the corresponding Bid Page of a particular embodiment is illustrated in FIG. 8. In the example embodiment, the Bid Page is structured in the following manner. The titles of each content item are displayed above each respective content item. Each content item is displayed on the war page, with ‘VS.’ dividing the competing content item from each other. Each General's player name is displayed underneath the content item which the General has deployed for the media war. Tags for each content item are displayed underneath the player name of the General. In certain media wars, a “Declare War On This Media” link will be displayed underneath the tags. The amount of time until the media war closes for bidding and therefore officially commences is displayed under “Declare War On This Media.” Expandable bid links which allow players to bid on each content item are displayed underneath the amount of time until the media war closes for bidding and therefore officially commences. These links will be displayed in the following manner “Bid on (MediaName).” A Bid Amount field, A Bid Against dropdown menu, and a Place Bid button are displayed on the bid page if a player clicks on either of the bid links. A link allowing players to flag the media war is displayed underneath the bid links. A link allowing players to fight a random media war is displayed underneath the Flag This Media War link. Empty fields allowing players to view or make comments is displayed underneath the Fight A Random War link. An “Add Comment” button, which allows players to add comments, is displayed next to the empty field. Previously made comments are displayed underneath the empty field, with the name of the commenter and the time of the comment also displayed.

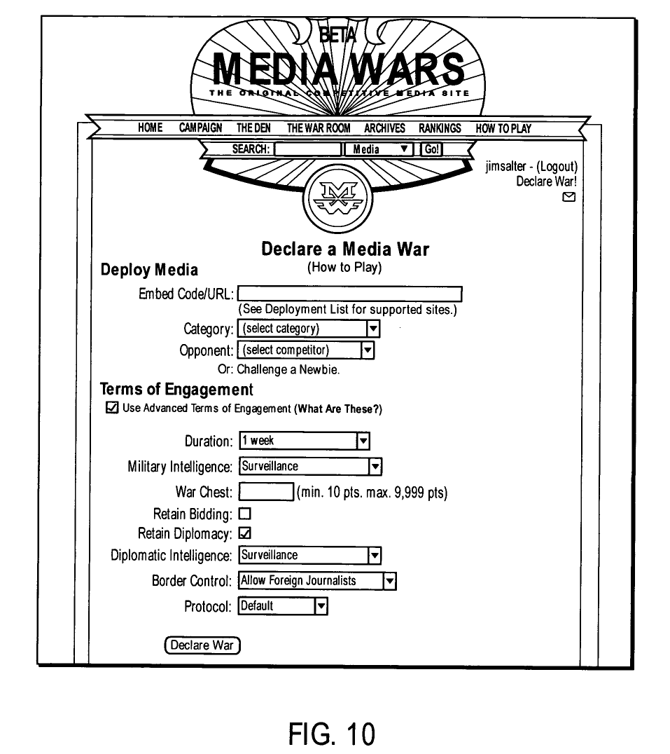

Referring again to FIG. 5, the Declare War Page (Attacker) module 243 is illustrated. Examples of the first corresponding Declare War Page (Attacker) of a particular embodiment are illustrated in FIGS. 9-10. In the example embodiment, the Declare War Page (Attacker) is structured in the following manner. The Declare War Page (Attacker) is divided into three major subsections: Deploy Media, Challenge Opponent, and Declare Terms of Engagement. The heading “Declare A Media War” is displayed at the top of the page. A “How To Play” link is displayed underneath the heading. This link opens a separate window which displays instructions. The “Deploy Media” subsection is displayed underneath the How To Play link. Empty field(s) and menu(s) are displayed within the “Deploy Media” subsection. In these empty field(s), players shall input the source of the content item he or she wishes to deploy. In the menu(s), players shall select a category for the content item that he or she is deploying. The “Challenge Opponent” subsection is displayed underneath the “Deploy Media” subsection. Empty field(s) and/or menu(s) are displayed within the “Challenge Opponent” subsection. Players shall input their opponent(s) player name in these empty field(s) and/or menu(s). A “Challenge A Newbie” link is displayed within the “Challenge Opponent” subsection. The “Challenge A Newbie” link opens up empty field(s) and/or menu(s). Players may enter contact information for another person ('newbie') within these field(s) and/or menu(s). The host site 110 can notify the newbie upon declaration of war. The “Terms of Engagement” subsection is displayed underneath the “Challenge Opponent” subsection. Empty field(s) and or menu(s) are displayed within the “Terms of Engagement” subsection. A “Duration of War” menu is displayed within the “Terms of Engagement” subsection. Players may select and thereby determine the duration of the media war within the “Duration of War” menu. The attacking player determines the duration of the media war by selecting the duration from the drop-down menu. The available War Durations are listed as follows: 3 hours, 6 hours, 12 hours, 24 hours, 48 hours, 3 days, 1 week, 1 fortnight, 1 month (30 days), 6 months, or 1 year.

An “Allow Bidding” checkbox is displayed underneath the “Duration of War” menu. Players may check this box to allow bidding to occur on the media war which the player is declaring. The attacking player may elect to allow or disallow bidding for this media war. If the attacker allows bidding, then other players may wager points on this media war. A “Bidding Period” menu is displayed underneath the “Allow Bidding” checkbox if a player checks the “Allow Bidding” checkbox. Players may determine the duration of the bidding period by selecting the bidding duration from the menu. The available Bid Durations are listed as follows: 1 day, 2 days, 3 days, 4 days, 5 days, 6 days, or 1 week.

A “War Chest” field is displayed underneath the “Allow Bidding” checkbox. The attacking player may decide to play for a War Chest. The War Chest is an initial bid made by the attacker against the defender. The attacker may specify the number of points wagered in the War Chest. The winner of the media war will win the points in the War Chest. The loser will lose the points in the War Chest. An “Intelligence” menu is displayed underneath the “War Chest” menu. Players may determine the manner in which scores are displayed. The available types of Intelligence are: Surveillance, Espionage, or Counter-Intelligence. The attacking player determines the manner in which scores are displayed. If a player selects Surveillance, the scores of this media war will be displayed throughout the competition. If a player selects Espionage, the score of the media war will only be displayed to a player after the player has fought in the media war. If a player selects Counter-Intelligence, the score of the media war will only be displayed when the media war finishes. A “Declare War” button is displayed underneath the “Intelligence” menu. Players may click this button to finalize the terms of their war declaration.

Referring again to FIG. 5, the Attack Page module 244 is illustrated. In the example embodiment, the Attack Page is structured in the following manner. A “Declare Media War” heading is displayed at the top of the Attack Page. A blank field(s) is displayed above each content item which is competing in the media war. The player who deployed the content item may modify or input text in this blank field in order to name or rename the content item. The content item is displayed below this blank field. Blank field(s) wherein the player who deployed the content item may add tags is displayed below the content item. The duration of the media war is displayed below these blank field(s). The bidding status and duration of the bidding round(s) is displayed below the duration of the media war. The value of the War Chest is displayed below the bidding status and duration of the bidding round(s). The Intelligence of the war is displayed below the value of the War Chest. An “Attack” button is displayed below the Intelligence of the War. Once a player clicks “Attack”, the player has officially and finally declared war, and may not revoke the war declaration. A “Go Back and Adjust War” button is displayed underneath the “Attack” button. If a player clicks “Go Back and Adjust War,” the player is redirected to the Declare War Page (Attacker).

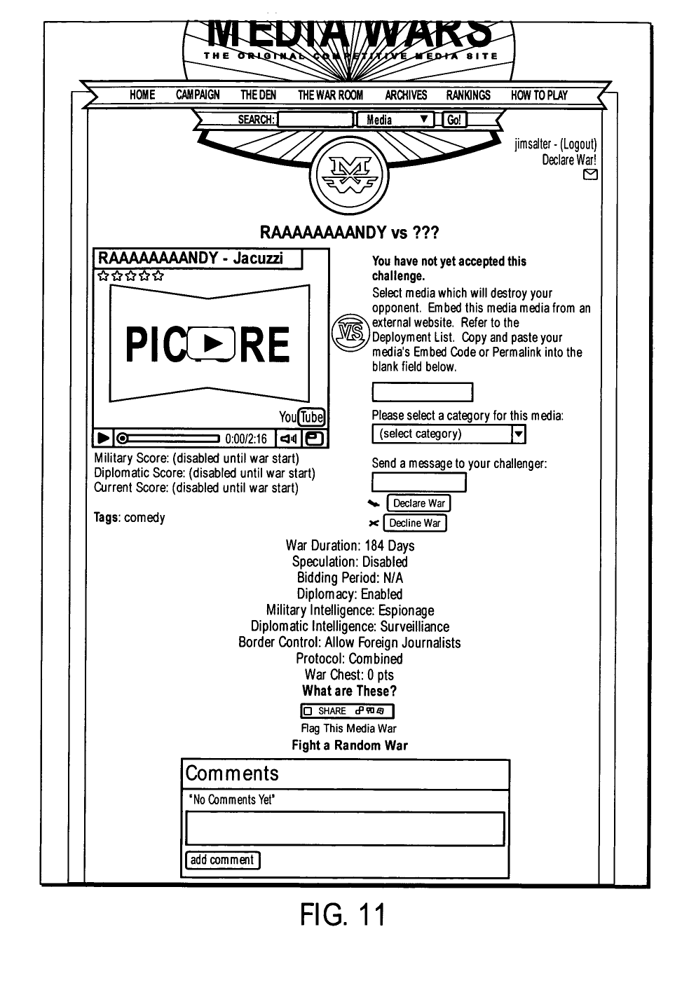

Referring again to FIG. 5, the Declare War Page (Defender) module 245 is illustrated. An example of the corresponding Declare War Page (Defender) of a particular embodiment is illustrated in FIG. 11. In the example embodiment, the Declare War Page (Defender) is structured in the following manner. A “Declare War” button is displayed on The Declare War Page (Defender). A “Decline War” button is displayed below the “Declare War.” button. Empty field(s) and menu(s) are displayed if a player clicks on “Declare War.” Empty field(s) wherein the player may input the source of the content item are displayed on the Defend Page. Menu(s) wherein the player may categorize the content item are displayed underneath the empty fields wherein the player inputs the source of the content item. The “Declare War” button is displayed underneath the categories menu.

Referring again to FIG. 5, the Defend Page module 246 is illustrated. An example of the corresponding Defend Page of a particular embodiment is illustrated in FIG. 11. In the example embodiment, the Defend Page is structured in the following manner. A “Declare Media War” heading is displayed at the top of the Defend Page. A blank field(s) is displayed above each content item which is competing in the media war. The player who deployed the content item may modify or input text in this blank field in order to name or rename the content item. The content item is displayed below this blank field. Blank field(s) wherein the player who deployed the content item may add tags is displayed below the content item. The duration of the media war is displayed below these blank field(s). The bidding status and duration of the bidding round(s) is displayed below the duration of the media war. The value of the War Chest is displayed below the bidding status and duration of the bidding round(s). The Intelligence of the media war is displayed below the value of the War Chest. In an alternative embodiment, a “Defend” button is displayed below the Intelligence of the War. Once a player clicks “Defend”, the player has officially and finally declared a media war, and may not revoke the media war declaration. A “Go Back and Adjust War” button is displayed underneath the “Defend” button. If a player clicks “Go Back and Adjust War,” the player is redirected to the Declare War Page (Defender).

War Declarations: Attackers must deploy content items, select their opponent(s), and determine the terms of engagement. Once attackers click “Attack,” the attacker's declaration of a media war becomes final, although defender(s) may elect to declare a media war, or decline a media war. Only the defenders' decision to declare a media war against the attacker will result in the commencement of war. After clicking “Attack,” the attacker may not revoke or modify the media war or any of the terms pertaining to the media war.

War Commencements: The media war shall begin as soon as a defender or defenders respond to an attack by declaring a media war against an attacker or attackers. The duration of the media war will be as specified by the attacker(s) before declaring a media war. The media war shall end when the time period specified by the attacker(s) elapses.

War Nullifications: In certain cases, an Umpire may elect to nullify a media war. No wins, losses, bids, or point allocations shall occur as a result of a nullified media war.

Circumstances for War Nullifications: War nullification may occur as a result of one of the following circumstances: any content item which was deployed into the media war breaks, becomes unavailable, is disabled, manipulated, flagged, or violates the host Terms of Use. In some cases, if a media war has completed 50% or more of its specified duration, and any of the above circumstances occur, the Umpire may elect to end the media war through Early Termination. If the Umpire elects to employ Early Termination, then all of the following events will occur: win declarations and allocations, loss declarations and allocations, bid allocations and losses, and any other point exchanges or allocations.

Additional Circumstances for War Nullifications: War nullification may also occur if a player or number of players is suspected of cheating. Cheating includes, but is not limited to, the following activities: deceptively manipulating content item deployment, war declaration, scores, points, or any of the gaming, business, and/or technical infrastructure of the host website, creating multiple players accounts, and/or falsely identifying oneself to players, visitors, or host players, users, visitors, umpires or related agents. In some cases where cheating is suspected, the Umpire will decide to end a media war or media wars early. If only one side of a media war is suspected of cheating, then the host may credit the non-cheating side with the win, regardless of the score.

Early Termination: In certain cases, an Umpire may elect to enact Early Termination for a media war. When this occurs, a winner is declared, a loser is declared, points are allocated to winning soldiers and generals, points are deducted from losing soldiers and generals, bid points are allocated to bid winners, and all statistics are finalized and displayed in player accounts.

Circumstances for Early Termination: Early Terminations may occur as a result of any of the following circumstances: any content item which was deployed into the media war breaks, becomes unavailable, is disabled, manipulated, flagged, or violates the host Terms of Use; unforeseen technical glitches interfere with the media war, or cheating is suspected of occurring.

Dispute Resolution: Umpires retain the right to nullify media wars and employ Early Termination. In some cases, Umpires may refer disputes to the host Executive Council. The host Executive Council may overrule or uphold an umpire's decision. The Executive Council may intervene and issue decisions on media wars referred by umpires, and media wars not referred by umpires. The Executive Council's decision involving any dispute shall be the final, ruling decision. Players who have grievances, or wish to file an appeal, can do so by emailing the Executive Council at a pre-defined appeal email address (e.g., appeals@host.com).

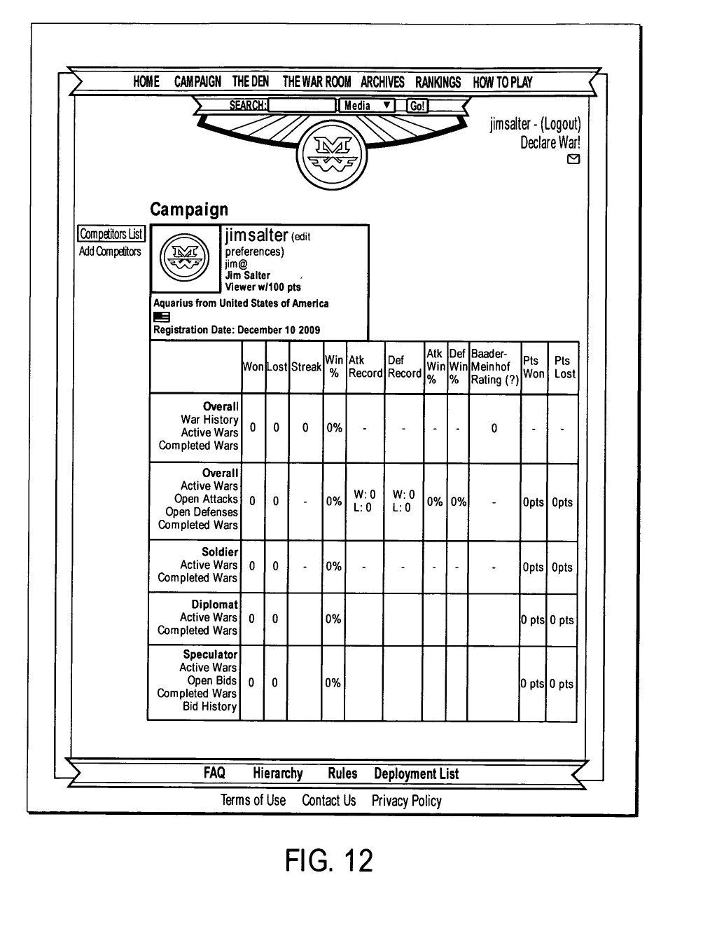

Referring again to FIG. 5, the Campaign Page module 247 is illustrated. An example of the corresponding Campaign Page of a particular embodiment is illustrated in FIG. 12. In the example embodiment, the Campaign Page displays the results of all of the media wars in which a particular user/player has been involved.

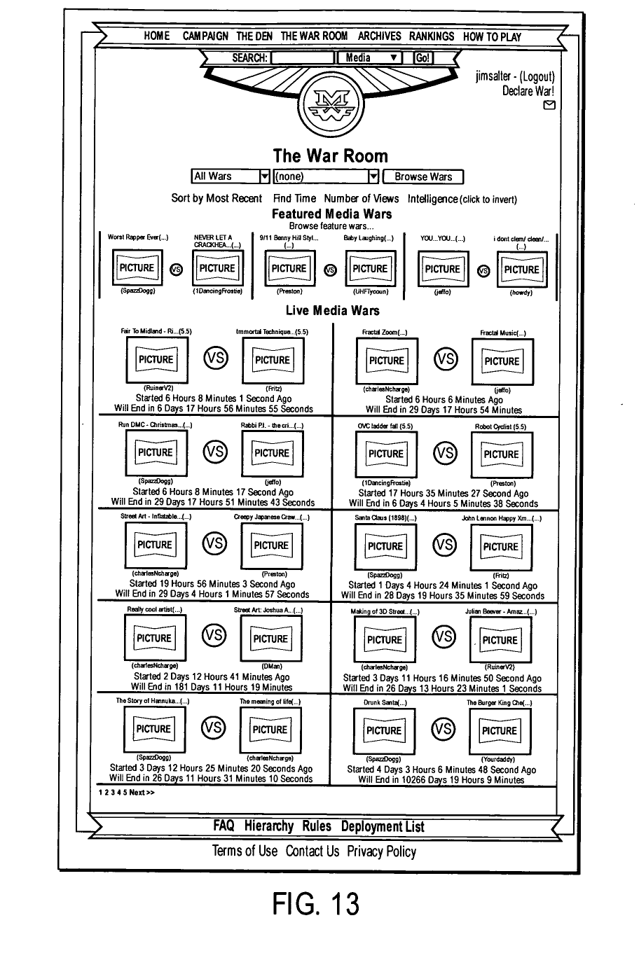

Referring again to FIG. 5, the War Room Page module 248 is illustrated. An example of the corresponding War Room Page of a particular embodiment is illustrated in FIG. 13. In the example embodiment, the War Room Page displays all of the featured and live media wars currently in play on the host site 110 at a particular time.

Referring again to FIG. 5, the Archives Page module 249 is illustrated. Upon completion of media wars, those completed media wars are then displayed only in the Archives Page. Players may view these completed media wars for eternity. All media wars which are displayed in the archives are final.

Referring again to FIG. 5, the Rankings Page module 250 is illustrated. An example of the corresponding Rankings Page of a particular embodiment is illustrated in FIG. 14. In the example embodiment, the Rankings Page displays the results of all of the media wars in which players have been involved. The Rankings Page is sorted to show the highest ranking player's (e.g., players with the highest relative cumulative scores) result data in the topmost portion of the Rankings Page.

Referring again to FIG. 5, the Border Control Page module 251 is illustrated. An example of the corresponding Border Control Page of a particular embodiment is illustrated in FIGS. 10-11. In the example embodiment, the Border Control Page and its related functionality is implemented in the following manner.

Border Control: An attacking general(s) may select one of the options within a Border Control submenu of the Border Control Page of the particular embodiment illustrated in FIG. 10. In a particular embodiment, the options listed include: “Allow Foreign Arms,” “Allow Foreign Journalists,” “Open Borders”, and “Seal Borders.” These options, and the related rules described in detail below, dictate how members of the general public (e.g., unregistered, casual visitors) are permitted to interact with a media war. In one embodiment, registered players are always allowed full permission to fight, negotiate, or bid on media wars. The attacking general(s) may elect to disallow members of the public (e.g., non-registered players) from voting in the media war in which s/he is the attacker. Thereby, the attacking general(s) can establish a de facto rule concerning the specified media wars: all registered players will be permitted to fight or negotiate the media war, depending upon the established Terms of Engagement. To enforce this rule, the attacking general(s) can select ‘Seal Borders’ within the Border Control submenu, located within the “Terms of Engagement.’ The attacking general(s) may also elect to permit non-registered players to negotiate the media war, but simultaneously disallow non-registered players from fighting in the media war. In this case, registered players may both fight or negotiate the media war, but non-registered players may only negotiate the media war and not fight in the media war. To enforce this rule, the attacking general(s) can select “Allow Foreign Journalists.” The attacking general(s) may also elect to permit non-registered players to fight a media war, but simultaneously disallow non-registered players from negotiating the media war. To enforce this rule, the attacking general(s) can select “Allow Foreign Arms” from the Border Control submenu. The attacking general(s) may also elect to permit members of the general public to fully interact with the media war, whether by fighting or negotiating the media war. To enforce this rule, the attacking general(s) can select “Open Borders.” Registered players may still fight or negotiate the media war, whichever they prefer.

Protocols: The attacking general(s) may also select options within a Protocols menu also shown in FIG. 10. In a particular embodiment, the options listed in the Protocols menu are “Genocide”, “Embargo”, and “Combine.” The attacking general(s) may choose to give more weight to military scores than diplomatic scores within the media war. If the attacking general(s) selects “Genocide” in the Protocols menu, then the following rules are applied:
If, at the end of a media war, more soldiers have played in the media war than diplomats, then the military score of each media determines the final result. The diplomatic score is omitted.
If, at the end of a media war, more diplomats have played in the media war than soldiers, then both scores are combined to determine the final result.
If, at the end of a media war, the same number of diplomats has played in the media war as soldiers, then military score again determines the final result.

If the attacking general(s) selects “Embargo” in the Protocols menu, then the following rules are applied:
If, at the end of a media war, more diplomats have played in the media war than soldiers, then the diplomatic score of each media determines the final result. The military score is omitted.
If, at the end of a media war, more soldiers have played in the media war than diplomats, then both scores are combined to determine the final result.
If, at the end of a media war, the same number of diplomats has played in the media war as soldiers, then both scores are combined to determine the final result.

If the attacking general(s) selects “Combine” in the Protocols menu, then the following rule is applied:

Both scores are combined to determine the final result.

Referring again to FIG. 3, the point allocation and statistical analysis module 250 is shown as part of the media competition system 200. The point allocation and statistical analysis module 250 handles the tallying and recording of points allocated to each competitor of each media war. The point allocation and statistical analysis module 250 can also use regression techniques to identify patterns in the scoring and bidding for various player types, roles, content items, content item categories, and the like. This data can be made available to any of the modules of the media competition system 200 for display to players, for analysis by the host site 110, or export to 3^{rd} parties via an application programming interface (API) provided in a particular embodiment by the media competition system 200. In a particular embodiment, point allocations and statistical allocations are handled by the point allocation and statistical analysis module 250 as follows.

Point Allocations: Upon completion of media wars, 25 points shall be allocated to the winning general(s), 10 points shall be allocated to the winning soldier(s), and the number of points which were bid by a speculator or speculators shall be allocated to the winning speculator or speculators. 5 points shall be deducted from the losing general(s) and 2 points shall be deducted from the losing soldier(s).

Statistical Allocations and Statistical Display: Upon completion of media wars, the following statistics can be displayed in each player's War History, Bid History, and Rankings box: Wins, Losses, Winning Percentage, Record as Attacker, Record as Defender, Winning Percentage as Attacker, Winning Percentage as Defender, Baader-Meinhof Rating, Bid Points Won, Bid Points Lost, Bids Won, Bids Lost, Highest Bid Won, and Highest Bid Lost. This data can be displayed in the Rankings Page, the Campaign Page, or others of the webpages provided in a particular embodiment.

Referring again to FIG. 3, the point redemption module 260 is shown as part of the media competition system 200. The point redemption module 260 handles the conversion of player points into other items of commensurate value. For example, a particular embodiment can provide a means for a player to cash in his/her points earned in fighting media wars for a corresponding amount of cash, goods, credits, or other value that a particular host site 110 can provide.

Referring again to FIG. 3, the advertising management module 270 is shown as part of the media competition system 200. The advertising management module 270 handles the assembly of information that may be useful for targeting advertising on the host site 110 or other 3^{rd} party sites. For example, the data generated by the point allocation and statistical analysis module 250 can be used by the advertising management module 270 to correlate and target particular advertisements or advertising types with users/players at the host site 110 based on the player types, roles, content items, content item categories, and the like that are most often used by particular players. The advertising management module 270 can also offer incentives to players who complete surveys. The results of these surveys can be added to a wealth of marketing information that can be mined from player interactions with the host site 110. This advertising and marketing data can be made available to any of the modules of the media competition system 200 for displaying advertising to players or for export to 3^{rd} parties via an application programming interface (API) provided in a particular embodiment by the media competition system 200.

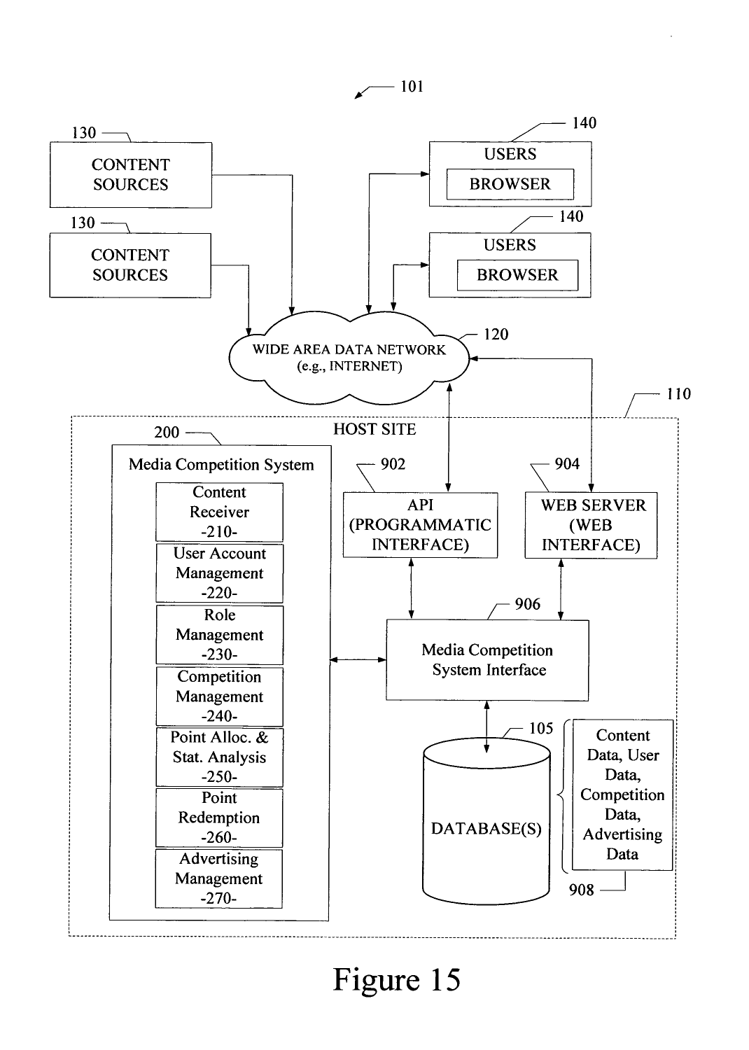

Referring now to FIG. 15, another example embodiment 101 of a networked system in which various embodiments may operate is illustrated. In the embodiment illustrated, the host site 110 is shown to include the media competition system 200. The media competition system 200 is shown to include the functional components 210-270, as described above. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the media competition system 200 either directly or via an interface 906. The media competition system 200 may be configured to access a data storage device 105 either directly or via the interface 906.

As described herein, the media competition system of various embodiments fuses at least three elements: competition, downloaded or streaming media, and modern gaming. The various embodiments create a competitive infrastructure in which players embed content items in media wars to determine which player wins, and which content item is superior. Using this solution, the public determines the result of media wars and the value of related content. In particular, the various embodiments foster several concepts: 1) creation of a market in which competition determines the value of media, 2) creation of a novel form of social networking based on competition, 3) creation of a large database of marketing research, 4) creation of interactive entertainment in which players directly interact with content, 5) creation of entertainment in which consumers dictate all content, and 6) creation of innovative advertising opportunities.

Ultimately, winners are rewarded in the various embodiments described herein, and losers are encouraged to play harder. This competitive structure drives players to find the best content possible, or at least the content with the greatest chance of victory. This competitive structure values content and players. It drives players to produce and interact with the highest quality content possible. The various embodiments therefore improve the quality of all content online, simply by subjecting it to the honest criticisms and emergent behaviors of players around the world.

People share content for many reasons. People share content with friends, family, coworkers, and other acquaintances. People even regularly share content with strangers. The various embodiments described herein create a game which makes sharing content more fun than passively sharing content through email or social networking websites.

Each content item's score will determine its qualitative value compared to other content. Marketing analysts, advertisers, and many other sectors of business highly value competitive marketing data. The Nielsen Group has grown to become one of the world's leading suppliers of marketing information. The various embodiments described herein connect media directly to consumers, similar to the Nielsen Group, but in a more game-like setting. The various embodiments offer incentives to players who complete surveys. These surveys are designed by advertisers and featured in the various embodiments described herein. These surveys are used to gather additional marketing data. The various embodiments create the largest focus group in the world, because the group is in fact the world. Furthermore, these “focus group” like scenarios are completed within the comfort of one's home (usually) and without the others in the group influencing one's opinions.

The new generation of consumers prefers to interact with content rather than passively view it. The proliferation of internet gaming, gaming consoles, and digital games reinforce this trend. The internet gaming industry is enjoying steady and progressive growth. Online streaming media has overtaken traditional forms of media in terms of popularity. The various embodiments described herein integrate gaming with online downloaded and streaming media in a fun and addictive fashion.

Players deploy content from around the internet. Therefore, in the various embodiments described herein, consumers are empowered to determine exactly what content is displayed on the host site. Consumers are empowered by the transparent competitive game created by the various embodiments.

A trend is forming wherein companies are creating more interactive forms of advertising. Many companies are choosing to advertise exclusively or prominently online, or even within games. Some even eschew other traditional forms of advertising. The various embodiments offer comprehensive advertising space and featured media wars. Advertisers can now play a prominent role in a massive online game, and thereby evoke a popular and positive response from players around the world.

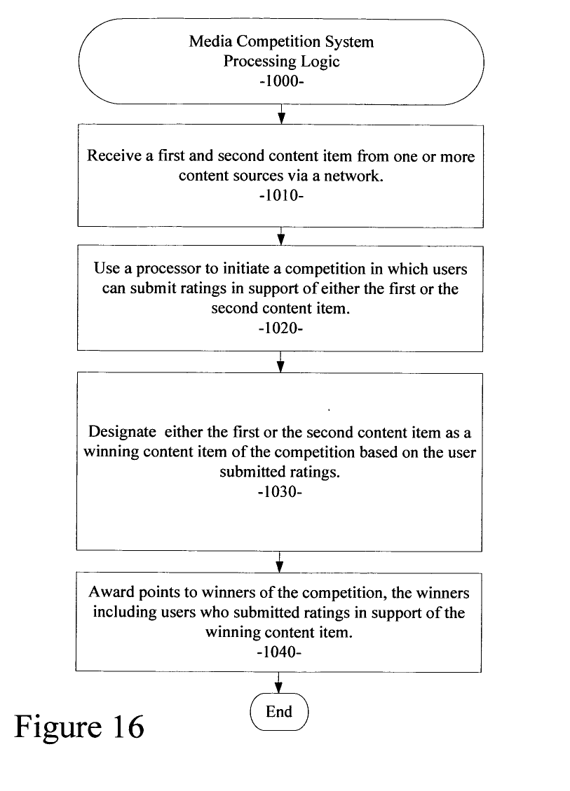

Referring now to FIG. 16, a processing flow diagram illustrates an example embodiment of a media competition system as described herein. The method of an example embodiment includes: receiving a first and second content item from one or more content sources via a network (processing block 1010); using a processor to initiate a competition in which users can submit ratings in support of either the first or the second content item (processing block 1020); designating either the first or the second content item as a winning content item of the competition based on the user submitted ratings (processing block 1030); and awarding points to winners of the competition, the winners including users who submitted ratings in support of the winning content item (processing block 1040).

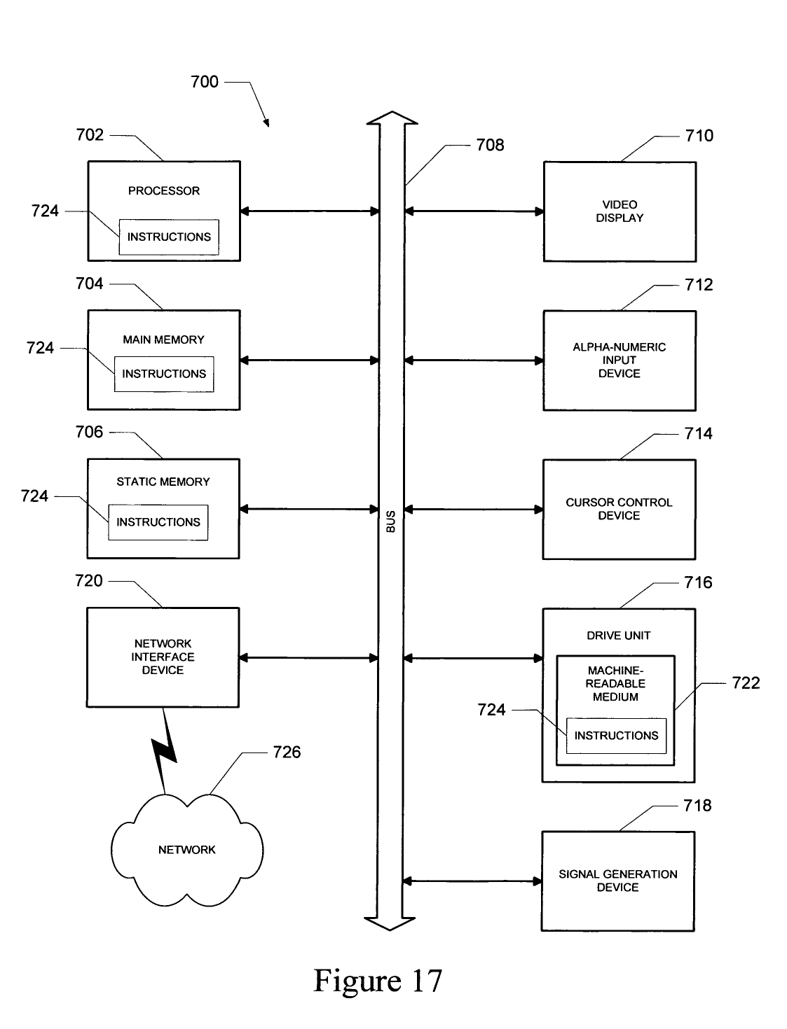

FIG. 17 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine Further, while only a single machine is illustrated, the term “machine” can also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” can also be taken to include any medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

We claim:

1. A computer-implemented method, comprising:
receiving a first and second content item from one or more content sources via a network;
using a processor to initiate a competition in which users can submit ratings in support of either the first or the second content item;
designating either the first or the second content item as a winning content item of the competition based on the user submitted ratings; and
awarding points to winners of the competition, the winners including users who submitted ratings in support of the winning content item.

2. The method as claimed in claim 1 wherein the winning content item is designated after a pre-determined time period has elapsed.

3. The method as claimed in claim 1 wherein the first and the second content item are from the group: 1) media items, 2) videos, 3) audio clips, 4) animations, 5) images, 6) graphics, 7) avatars, and 8) objects representing: physical objects, products, people, events, documents, creative works, business entities, or expressed ideas.

4. The method as claimed in claim 1 wherein the first and the second content item are received from a website.

5. The method as claimed in claim 1 wherein a user can assume a role in a competition, the role being from the group: diplomat, soldier, general, and speculator.

6. The method as claimed in claim 5 wherein an attacking general in a competition can declare war on another general, the attacking general winning a first pre-defined number of points if the attacking general deployed the winning content item, the attacking general winning a second pre-defined number of points if the attacking general did not deploy the winning content item.

7. The method as claimed in claim 1 wherein users can submit bids in support of either the first or the second content item, the winners including users who submitted bids in support of the winning content item.

8. The method as claimed in claim 5 wherein an attacking general in a competition can declare war on another general, the attacking general winning a first pre-defined number of points if the attacking general deployed the winning content item, the attacking general losing a second pre-defined number of points if the attacking general did not deploy the winning content item.

9. The method as claimed in claim 5 wherein a diplomat in a competition can submit ratings in support of either the first or the second content item, the diplomat winning a pre-defined number of points if the diplomat supported the winning content item.

10. The method as claimed in claim 5 wherein speculator in a competition can submit bids in support of either the first or the second content item, the speculator winning a number of points corresponding to a bid amount if the speculator submitted a bid in support of the winning content item, the speculator losing a number of points corresponding to the bid amount if the speculator bid in support of a losing content item.

11. A system, comprising:
a processor;
a database, in data communication with the processor, for storage of content information and competition information; and
a media competition module, executable by the processor, to:
receive a first and second content item from one or more content sources via a network;
initiate a competition in which users can submit ratings in support of either the first or the second content item;
designate either the first or the second content item as a winning content item of the competition based on the user submitted ratings; and
award points to winners of the competition, the winners including users who submitted ratings in support of the winning content item.

12. The system as claimed in claim 11 wherein the winning content item is designated after a pre-determined time period has elapsed.

13. The system as claimed in claim 11 wherein the first and the second content item are from the group: 1) media items, 2) videos, 3) audio clips, 4) animations, 5) images, 6) graphics, 7) avatars, and 8) objects representing: physical objects, products, people, events, documents, creative works, business entities, or expressed ideas.

14. The system as claimed in claim 11 wherein the first and the second content item are received from a website.

15. The system as claimed in claim 11 wherein a user can assume a role in a competition, the role being from the group: diplomat, soldier, general, and speculator.

16. The system as claimed in claim 15 wherein an attacking general in a competition can declare war on another general, the attacking general winning a first pre-defined number of points if the attacking general deployed the winning content item, the attacking general winning a second pre-defined number of points if the attacking general did not deploy the winning content item.

17. The system as claimed in claim 11 wherein users can submit bids in support of either the first or the second content item, the winners including users who submitted bids in support of the winning content item.

18. The system as claimed in claim 15 wherein an attacking general in a competition can declare war on another general, the attacking general winning a first pre-defined number of points if the attacking general deployed the winning content item, the attacking general losing a second pre-defined number of points if the attacking general did not deploy the winning content item.

19. The system as claimed in claim 15 wherein a diplomat in a competition can submit ratings in support of either the first or the second content item, the diplomat winning a pre-defined number of points if the diplomat supported the winning content item.

20. The system as claimed in claim 15 wherein speculator in a competition can submit bids in support of either the first or the second content item, the speculator winning a number of points corresponding to a bid amount if the speculator submitted a bid in support of the winning content item, the speculator losing a number of points corresponding to the bid amount if the speculator bid in support of a losing content item.

21. A machine-useable storage medium embodying instructions which, when executed by a machine, cause the machine to:
receive a first and second content item from one or more content sources via a network;
initiate a competition in which users can submit ratings in support of either the first or the second content item;
designate either the first or the second content item as a winning content item of the competition based on the user submitted ratings; and
award points to winners of the competition, the winners including users who submitted ratings in support of the winning content item.
